(19) United States
(12) Patent Application Publication
(10) Pub. No.: US 2013/0093545 A1
(43) Pub. Date: Apr. 18, 2013

(54) MAGNETO-RESISTANCE QUADRUPOLE MAGNETIC CODED SWITCH

(71) Applicants: Gangi Reddy Rajula, Cuddapah District (IN); Balaji K. Krishnaswamy, Bangalore (IN); Girish Krishnaiah, Bangalore (IN)

(72) Inventors: Gangi Reddy Rajula, Cuddapah District (IN); Balaji K. Krishnaswamy, Bangalore (IN); Girish Krishnaiah, Bangalore (IN)

(73) Assignee: HONEYWELL INTERNATIONAL INC., Morristown, NJ (US)

(21) Appl. No.: 13/276,158

(22) Filed: Oct. 18, 2011

(51) Int. Cl. H01H 9/00

(52) U.S. Cl. 335/207

(57) ABSTRACT

A quadrupole magnetic coded switch includes a switch housing, an actuator housing, a first pair of actuator dipole magnets, a first pair of switch dipole magnets, and a pair of first magneto-resistance (MR) sensors. The actuator housing is movable relative to the switch housing. The first pair of actuator dipole magnets is coupled to the actuator housing and is movable therewith, and the first pair of switch dipole magnets is coupled to the switch housing. The first pair of actuator dipole magnets and the first pair of switch dipole magnets are arranged to generate a first quadrupole magnetic field. Each of the first MR sensors is disposed within the switch housing and is configured to vary in resistance in response to relative movement of the actuator housing and the switch housing.

### TECHNICAL FIELD

The present invention generally relates to magnetically operated switches, and more particularly relates to a magneto-resistance quadrupole magnetic coded switch.

### BACKGROUND

Various types of switches have been implemented to provide protection to both systems and personnel. Such switches, when provided, ensure that electrical power is available to at least certain portions of a system only when certain components are in predetermined positions with respect to each other. For example, one or more switches may be included in a system to ensure that separately driven parts of the system do not collide with each other.

Such switches may also be used to provide electrical power to energize one portion of a system only when a second portion is out of the path of a first portion. These switches may also be used to ensure that a machine or system operator is not within the vicinity of certain parts of a machine or system, such as in cutting, grinding, forging, or punching machines or systems, before power is made available to drive these parts.

The above-described switches have been variously implemented and configured. In many instances, these switches are mechanically or magnetically operated devices. While reliable, presently known mechanically and magnetically operated switches do exhibit certain drawbacks. For example, presently known mechanically and magnetically operated switches may be readily overridden by an operator in the interest of faster machine or system operation.

Hence there is a need for a tamper resistant switch and/or a switch that is not readily overridden, to ensure adequate levels of safety margin for machines and machine operators. The instant invention addresses at least this need.

### BRIEF SUMMARY

In one embodiment, a quadrupole magnetic coded switch includes a switch housing, an actuator housing, a first pair of actuator dipole magnets, a first pair of switch dipole magnets, and a pair of first magneto-resistance (MR) sensors. The actuator housing is movable relative to the switch housing. The first pair of actuator dipole magnets is coupled to the actuator housing and is movable therewith, and the first pair of switch dipole magnets is coupled to the switch housing. The first pair of actuator dipole magnets and the first pair of switch dipole magnets are arranged to generate a first quadrupole magnetic field. Each of the first MR sensors is disposed within the switch housing and is configured to vary in resistance in response to relative movement of the actuator housing and the switch housing.

In another embodiment, a magneto-resistance quadrupole magnetic coded switch system includes a switch housing, an actuator housing, a first pair of actuator dipole magnets, a first pair of switch dipole magnets, a pair of first magneto-resistance (MR) sensors, and processing circuitry. The actuator housing is movable relative to the switch housing. The first pair of actuator dipole magnets is coupled to the actuator housing and is movable therewith. The first pair of switch dipole magnets is coupled to the switch housing. The first pair of switch dipole magnets and the first pair of actuator dipole magnets are arranged to generate a first quadrupole magnetic field. Each of the first MR sensors is disposed within the switch housing and is configured to vary in resistance in response to relative movement of the actuator housing and the switch housing. The processing circuitry is coupled to the first MR sensors and is configured, in response to variations in the resistance of the first MR sensors, to supply one or more switched output signals.

Furthermore, other desirable features and characteristics of the magneto-resistance quadrupole magnetic coded switch will become apparent from the subsequent detailed description, taken in conjunction with the accompanying drawings and this background.

### BRIEF DESCRIPTION OF THE DRAWINGS

The present invention will hereinafter be described in conjunction with the following drawing figures, wherein like numerals denote like elements, and wherein:

FIG. 1 depicts a functional schematic diagram of an embodiment of a magneto-resistance quadrupole magnetic coded switch;

FIGS. 2 and 3 depict functional schematic representations of single-axis and two-axis anisotropic magneto-resistance sensors;

FIG. 4 depicts a functional schematic diagram of a second embodiment of a magneto-resistance quadrupole magnetic coded switch;

FIG. 5 depicts a functional schematic diagram of a another embodiment of a magneto-resistance quadrupole magnetic coded switch;

FIG. 6 depicts a functional schematic diagram of a fourth embodiment of a magneto-resistance quadrupole magnetic coded switch; and

FIG. 7 depicts a functional schematic diagram of processing circuitry that may be used with the magneto-resistance quadrupole magnetic coded switches of FIGS. 1 and 4-6.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

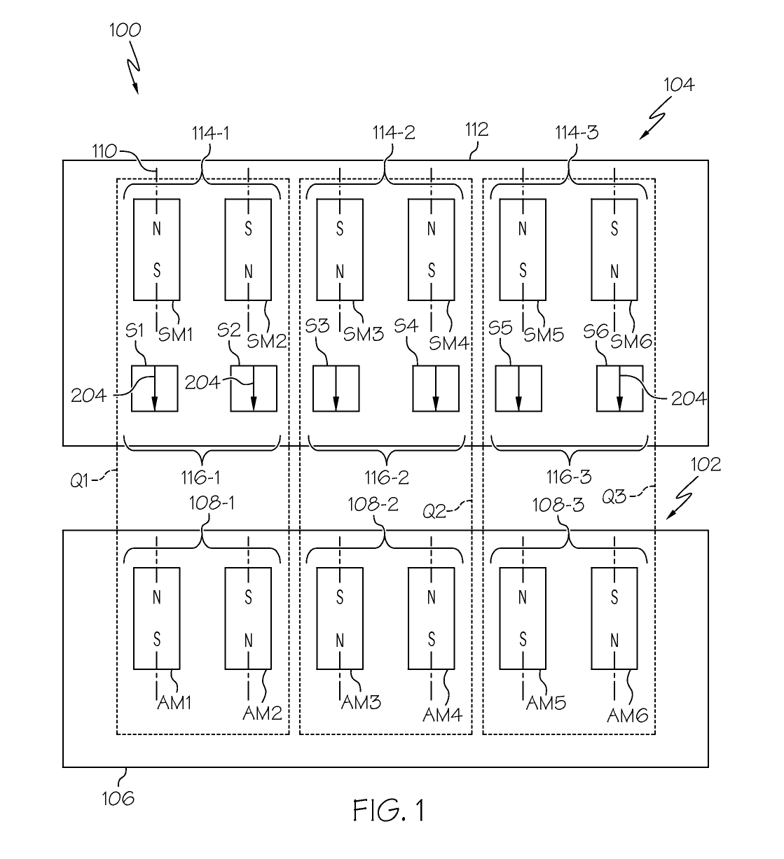

A functional schematic diagram of an embodiment of a quadrupole magnetic coded switch is depicted in FIG. 1. The switch 100 includes an actuator assembly 102 and a switch assembly 104. The actuator assembly 102 includes an actuator housing 106 and plural pairs of dipole magnets 108, which are referred to herein as pairs of actuator dipole magnets. In the embodiment depicted in FIG. 1, the actuator assembly 102 includes three pair of actuator dipole magnets 108—a first pair of actuator dipole magnets 108-1 (AM1, AM2), a second pair of actuator dipole magnets 108-2 (AM3, AM4), and a third pair of actuator dipole magnets 108-3 (AM5, AM6)—that are coupled to the actuator housing 106. However, it will be appreciated that in other embodiments the actuator assembly 102 could be implemented with more or less than this number of pairs of actuator dipole magnets 108. Moreover, although the actuator dipole magnets 108 are preferably implemented using permanent magnets, electromagnets could also be used.

The switch assembly 104 includes a switch housing 112, plural pairs of dipole magnets 114, which are referred to herein as pairs of switch dipole magnets, and plural pairs of magneto-resistive (MR) sensors 116. The pairs of switch dipole magnets 114 are each coupled to the switch housing 112 and, in the depicted embodiment, includes three pair of switch dipole magnets—a first pair of switch dipole magnets 114-1 (SM1, SM2), a second pair of switch dipole magnets 114-2 (SM3, SM4), and a third pair of switch dipole magnets 114-3 (SM5, SM6). It will be appreciated that in other embodiments the switch assembly 104 could be implemented with more or less than this number of pairs of switch dipole magnets 114. As with the actuator dipole magnets 108, although the switch dipole magnets 114 are preferably implemented using permanent magnets, electromagnets could also be used.

No matter the specific number of pairs of actuator dipole magnets 108 and pairs of switch dipole magnets 114, each of these dipole magnets 108, 114, as is generally known, includes a north pole (N) and a south pole (S). The actuator and switch dipole magnets 108, 114 also each include a magnetic axis 110, which is defined herein as a line that extends through the center of the magnets 108, 114 and through the north (N) and south (S) poles thereof. As FIG. 1 further depicts, the individual actuator dipole magnets (AM1, AM2, AM3, AM4, AM5, AM6) that comprise each pair of actuator dipole magnets 108, and the individual switch dipole magnets (SM1, SM2, SM3, SM4, SM5, SM6) that comprise each pair of switch dipole magnets 114, are arranged such that opposing magnetic polarities are adjacent to each other. As a result of this arrangement, the associated pairs of actuator dipole magnets 108 and switch dipole magnets 114 generate a quadrupole magnetic field, which are each represented by the dashed-line rectangles in FIG. 1. That is, the first pair of actuator dipole magnets 108-1 and the first pair of switch dipole magnets 114-1 are arranged to generate a first quadrupole magnetic field (Q1). Similarly, the second pair of actuator dipole magnets 108-2 and the second pair of switch dipole magnets 114-2 are arranged to generate a second quadrupole magnetic field (Q2), and the third pair of actuator magnets 108-3 and the third pair of switch dipole magnets 114-3 are arranged to generate a third quadrupole magnetic field (Q3).

Before proceeding further, it is noted that the actuator assembly 102 is preferably movable relative to the switch assembly 104. Thus, in most embodiments the actuator housing 106 is coupled to a movable portion of a particular device, system, or machine such as, for example, a machine guard, a door, or any one of numerous other movable portions. Concomitantly, the switch housing 112 is preferably coupled to a stationary portion of the same particular device, system, or machine as the actuator housing 106.

The pairs of MR sensors 116 are disposed within the switch housing 112. As will be described momentarily, each MR sensor 116 is configured to vary in resistance in response to the relative movement of the actuator housing 106 and the switch housing 112, and more specifically based on the relative strength of the quadrupole magnetic fields. Although the number of MR sensors 116 may vary, in the depicted embodiment the switch assembly 104 includes three pair of MR sensors 116—a pair of first MR sensors 116-1 (S1, S2), a pair of second MR sensors 116-2 (S3, S4), and a pair of third MR sensors 116-3 (S5, S6)—with each pair of MR sensors 116 being associated with one pair of actuator dipole magnets 108 and one pair of switch dipole magnets 114. In particular, the pair of first MR sensors 116-1 is associated with the first pair of actuator dipole magnets 108-1 and the first pair of switch dipole magnets 114-1, the pair of second MR sensors 116-2 is associated with the second pair of actuator dipole magnets 108-2 and the second pair of switch dipole magnets 114-2, and the pair of third MR sensors 116-3 is associated with the third pair of actuator dipole magnets 108-3 and the third pair of switch dipole magnets 114-3.

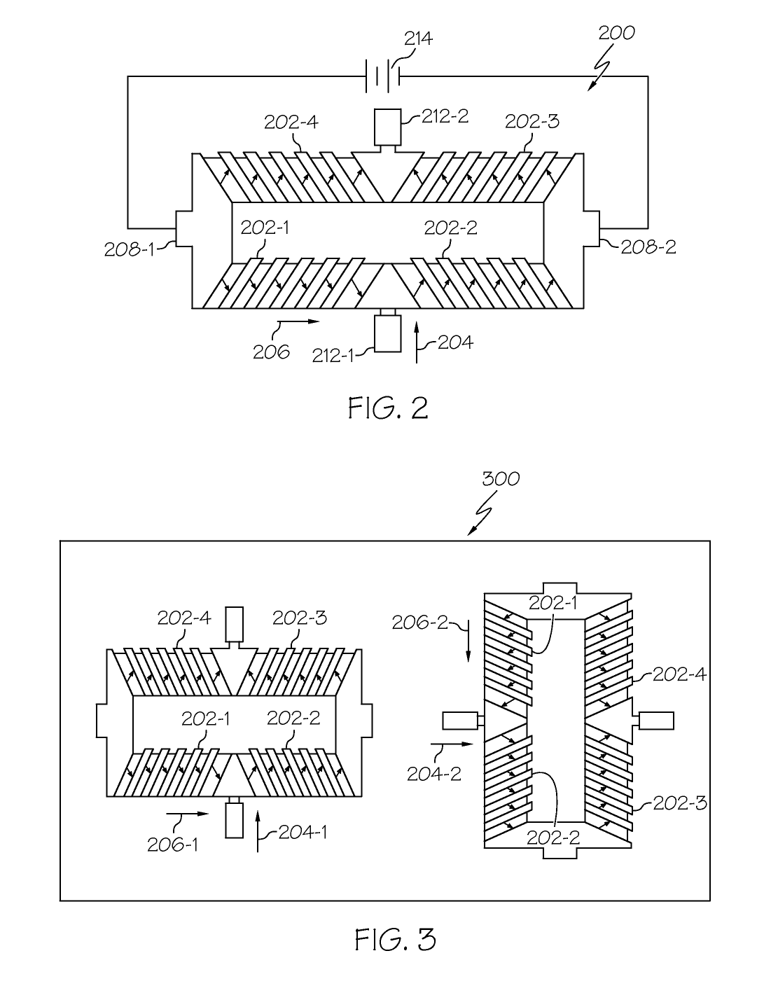

It will be appreciated that the MR sensors 116 may be implemented using any one of numerous types of MR sensors. For example, the MR sensors 116 may be implemented using AMR (anisotropic magneto-resistance) sensors or GMR (giant magneto-resistance) sensors. In the depicted embodiments, however, the MR sensors 116 are each implemented using AMR sensors, which may be either single-axis or two-axis AMR sensors. Embodiments of single-axis and two-axis AMR sensors 200, 300 are depicted in FIGS. 2 and 3, and for completeness will now be briefly described.

The exemplary single-axis AMR sensor 200 that is depicted in FIG. 2 includes a plurality of resistive elements 202 (e.g., 202-1, 202-1, 202-3, 202-4) connected in a Wheatstone bridge configuration. The resistive elements 202 are also arranged such that the AMR sensor 200 has what is generally referred to as a “magnetic sensitive axis” 204 and a “magnetic easy axis” 206. The resistive elements 202 comprise a material, such as permalloy thin films, that vary in electrical resistance in response to magnetic fields in the magnetic sensitive axis 204, but do not vary in electrical resistance in response to magnetic fields in the magnetic easy axis 206.

The depicted AMR sensor 200 includes four resistive elements, with opposing resistive elements (e.g., 202-1 and 202-3, 202-2 and 202-4) being identical. The AMR sensor 200 additionally includes two input terminals 208-1, 208-2 and two output terminals 212-1, 212-2. Preferably, an electric power source 214, such as a regulated DC voltage source, is coupled across the two input terminals 208-1, 208-1. Thus, if a positive magnetic field is applied in the magnetic sensitive axis 204, meaning a magnetic field in the magnetic sensitive axis 204 and in the direction in which arrow 204 is pointing, then resistive elements 202-1 and 202-3 will increase in resistance and resistive elements 202-2 and 202-4 will decrease in resistance. As a result, the voltage magnitude across the output terminals 212-1, 212-2 will increase, and have a positive polarity. Conversely, if a negative magnetic field is applied in the magnetic sensitive axis 204, meaning a magnetic field in the magnetic sensitive axis 204 and in the direction opposite that which arrow 204 is pointing, then resistive elements 202-1 and 202-3 will decrease in resistance and resistive elements 202-2 and 202-4 will increase in resistance. As a result, the voltage magnitude across the output terminals 212-1, 212-2 will also increase, but have a negative polarity.

The exemplary two-axis AMR sensor 300 depicted in FIG. 3 includes two of the single-axis AMR sensors 200 (e.g., 200-1, 200-2) depicted in FIG. 2. However, the individual single-axis AMR sensors 200 that comprise the two-axis AMR sensor 300 are mounted such that their respective magnetic sensitive axes 204-1, 204-2 are disposed perpendicularly. Thus, the two-axis AMR sensor 300 is able to break a magnetic field into two perpendicular vector components.

In the embodiment depicted in FIG. 1, it is seen that for each pair of MR sensors 116, both of the MR sensors 200, 300 in each pair are identically disposed. That is, all of the MR sensors 200, 300 are disposed such that their magnetic sensitive axes 204 are in the same direction. With this arrangement of the MR sensors 200, 300 and of the associated pairs of actuator dipole magnets 108 and switch dipole magnets 114, the variations in the output voltages of the individual MR sensors 200, 300 of each pair of MR sensors 116 will be opposite in polarity. More specifically, the variation in the output voltage of S1 will be opposite in polarity to that of S2, the variation in the output voltage of S3 will be opposite in polarity to that of S4, and the variation in the output voltage of S5 will be opposite in polarity to that of S6. However, as may be appreciated the variations in the polarity of the output voltages of S1, S2, S5, and S6 will be identical, or at least similar.

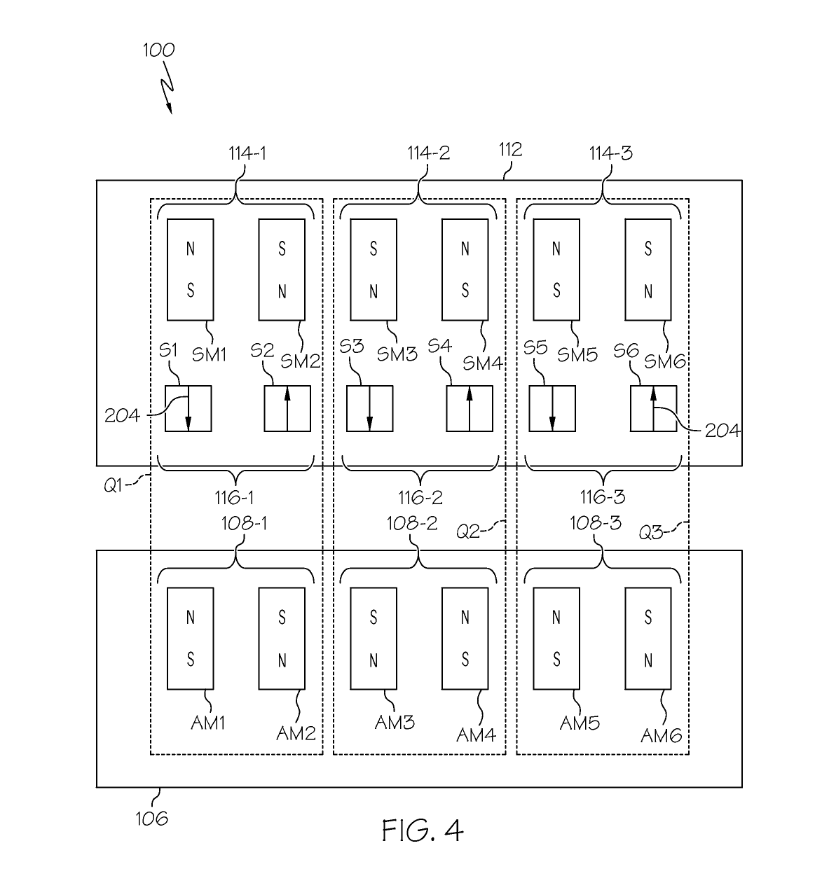

It will be appreciated that the embodiment depicted in FIG. 1 and described above is merely exemplary, and that in other embodiments, such as the one depicted in FIG. 4, the MR sensors 200, 300 that comprise each pair of MR sensors 116 could be disposed such that their magnetic sensitive axes 204 are in opposite directions. As may be readily appreciated, unlike the embodiment depicted in FIG. 1, in the embodiment depicted in FIG. 4, the relative polarities of the sensor output voltages of the MR sensors 200, 300 that comprise each pair of MR sensors 116 will be identical. That is, the variation in the output voltages of S1 and S2 will have the same polarity, the variation in the output voltages of S3 and S4 will have the same polarity, and the variation in the output voltages of S5 and S6 will have the same polarity.

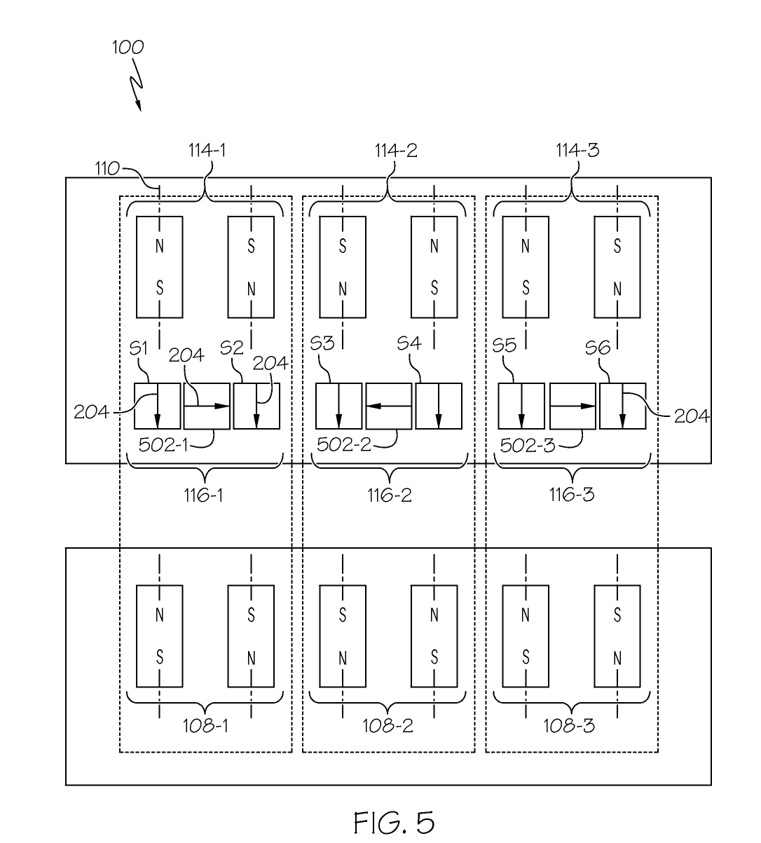

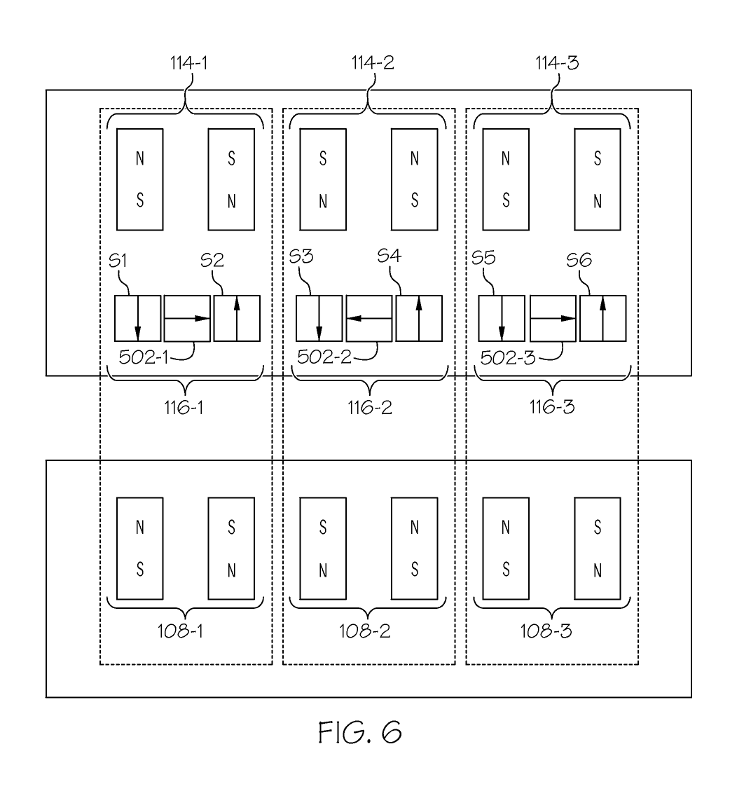

In some embodiments, the switch 100 may additionally include a plurality of interposed MR sensors 502, one associated with each pair of MR sensors 116. Thus, for the embodiments depicted in FIGS. 5 and 6, the switch 100 additionally includes three interposed MR sensors 502—a first interposed MR sensor 502-1, a second interposed MR sensor 502-2, and a third interposed MR sensor 502-3. The first interposed MR sensor 502-1 is preferably disposed between the pair of first MR sensors 116-1, the second interposed MR sensor 502-2 is preferably disposed between the pair of second MR sensors 116-2, and the third interposed MR sensor 502-3 is preferably disposed between the pair of third MR sensors 116-3. In the embodiments depicted in FIGS. 1 and 4-6, the individual MR sensors 200, 300 that comprise the pairs of MR sensors 116 are disposed such that their magnetic sensitive axes 204 lie along, or are at least parallel to, the magnetic axes 110 of each of the associated pairs of actuator dipole magnets 108 and switch dipole magnets 118. However, as FIGS. 5 and 6 depict, the interposed MR sensors 502 are disposed such that their magnetic sensitive axes 204 are perpendicular to the magnetic axes 110 of each of its associated pair of actuator dipole magnets 108 and switch dipole magnets 114.

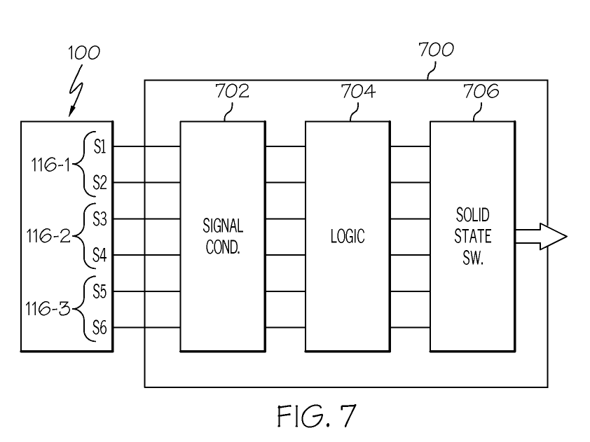

The quadrupole magnetic coded switches depicted in FIGS. 1 and 4-6 and described above are each preferably coupled to processing circuitry that is configured, in response to the variations in the resistance of the MR sensors 116, to supply one or more switched output signals. It will be appreciated that the processing circuitry may be variously implemented. One particular implementation of the processing circuitry, in accordance with one embodiment, is depicted in FIG. 7 and with reference thereto will now be described.

The depicted processing circuitry 700 includes signal conditioning circuitry 702, logic circuitry 704, and solid state switching circuitry 706. The signal conditioning circuitry 702 is coupled to receive the output signals supplied from each of the MR sensors 116. As may be appreciated, the output signals from the MR sensors 116 are representative of the variations in the resistances of the MR sensors 116, which are in turn representative of the relative proximities of the actuator housing 102 and the switch housing 104. The signal conditioning circuitry 702 is configured to amplify and filter the output signals, and implement suitable threshold or comparison functions to supply logic-level signals (e.g., logic-level HIGH/logical “1” or logic-level LOW/logical “0”) to the logic circuitry 704.

Before describing the remainder of the processing circuitry 700, it was noted above that the MR sensors 116 may be variously disposed within the switch housing 112. For example, the magnetic sensitive axis 204 of each MR sensor in a pair of MR sensors 116 may be disposed in the same direction or in opposite directions. The disposition of the MR sensors may be varied so that its associated output signal, after being processed by the signal conditioning circuitry 702 will be either a logic-level HIGH signal or a logic-level LOW signal when the actuator housing 106 and the switch housing 112 are moved toward, and are within a first predetermined distance of, each other, and will be the opposite logic-level signal when the actuator housing 106 is moved away from, and is a second predetermined distance from, the switch housing 112.

Turning now to the logic circuitry 704, this circuitry receives the logic-level signals from the signal processing circuitry 702 and, implementing any one or combinations of Boolean operations (e.g., AND, OR, NAND, NOR, etc.), supplies switch signals to the solid state switching circuitry 706. The Boolean operations that the logic circuitry 704 implements may vary, and may be selected to supply a first binary output from the logic circuitry 704 when the actuator housing 106 and the switch housing 112 are moved toward, and are within the first predetermined distance of, each other, and supply a second binary output when the actuator housing 106 is moved away from, and is the second predetermined distance from, the switch housing 112.

The solid state switch circuitry 706 is coupled to receive the switch signals and is configured, in response thereto, to selectively turn a plurality of solid state switches ON or OFF. In one particular embodiment, the solid state switches are implemented using MOSFFETs. As such, each of the MOSFETs is placed into a conductive or non-conductive state in response to the switch signals it receives, to thereby supply the one or more switched output signals.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention.

1. A magneto-resistance quadrupole magnetic coded switch, comprising:
a switch housing;
an actuator housing movable relative to the switch housing;
a first pair of actuator dipole magnets coupled to the actuator housing and movable therewith;
a first pair of switch dipole magnets coupled to the switch housing, the first pair of switch dipole magnets and the first pair of actuator dipole magnets arranged to generate a first quadrupole magnetic field; and
a pair of first magneto-resistance (MR) sensors, each first MR sensor disposed within the switch housing and configured to vary in resistance in response to relative movement of the actuator housing and the switch housing.

2. The switch of claim 1, further comprising an electric power source coupled to each of the first MR sensors.

3. The switch of claim 2, wherein:
each first MR sensor has a magnetic sensitive axis; and
each first MR sensor, when coupled to the electric power source and supplied with current therefrom, supplies a sensor output voltage having a voltage magnitude proportional to magnetic field strength supplied thereto along the magnetic sensitive axis.

4. The switch of claim 3, wherein:
the sensor output voltage supplied from each first MR sensor has a relative polarity; and
the relative polarities of the sensor output voltages of the first MR sensors are identical.

5. The switch of claim 3, wherein:
the sensor output voltage supplied from each first MR sensor has a relative polarity; and
the relative polarities of the sensor output voltages of the first MR sensors are opposite.

6. The switch of claim 1, further comprising:
a second pair of actuator dipole magnets coupled to the actuator housing and movable therewith, the second pair of actuator dipole magnets spaced apart from the first pair of actuator dipole magnets;
a second pair of switch dipole magnets coupled to the switch housing and spaced apart from the first pair of switch dipole magnets, the second pair of switch dipole magnets and the second pair of actuator dipole magnets arranged to generate a second quadrupole magnetic field; and
a pair of second MR sensors disposed within the switch housing and configured to vary in resistance in response to relative movement of the actuator housing and the switch housing.

7. The switch of claim 6, further comprising:
a third pair of actuator dipole magnets coupled to the actuator housing and movable therewith, the third pair of actuator dipole magnets spaced apart from the first and second pairs of actuator dipole magnets;
a third pair of switch dipole magnets coupled to the switch housing and spaced apart from the first and second pairs of switch dipole magnets, the third pair of switch dipole magnets and the third pair of actuator dipole magnets arranged to generate a third quadrupole magnetic field; and
a pair of third MR sensors disposed within the switch housing and configured to vary in resistance in response to relative movement of the actuator housing and the switch housing.

8. The switch of claim 7, wherein each of the first, second, and third MR sensors is a single-axis MR sensor.

9. The switch of claim 7, wherein each of the first, second, and third MR sensors is a two-axis MR sensor.

10. The switch of claim 1, further comprising a first interposed MR sensor disposed between the pair of first MR sensors and configured to vary in resistance in response to relative movement of the actuator housing and the switch housing.

11. The switch of claim 10, wherein:
the first pair of actuator dipole magnets and the first pair of switch dipole magnets each have a magnetic axis;
the pair of first MR sensors each have a magnetic sensitive axis that lies along, or is at least parallel to, the magnetic axes of the first pair of actuator dipole magnets and the first pair of switch dipole magnets; and
the first interposed MR sensor has a magnetic sensitive axis that is perpendicular to the magnetic axes of the first pair of actuator dipole magnets and the first pair of switch dipole magnets.

12. The switch of claim 11, further comprising:
a second pair of actuator dipole magnets coupled to the actuator housing and movable therewith, the second pair of actuator dipole magnets spaced apart from the first pair of actuator dipole magnets;
a second pair of switch dipole magnets coupled to the switch housing and spaced apart from the first pair of switch dipole magnets, the second pair of switch dipole magnets and the second pair of actuator dipole magnets arranged to generate a second quadrupole magnetic field;
a pair of second MR sensors disposed within the switch housing and configured to vary in resistance in response to relative movement of the actuator housing and the switch housing; and
a second interposed MR sensor disposed between the pair of second MR sensors and configured to vary in resistance in response to relative movement of the actuator housing and the switch housing.

13. The switch of claim 12, wherein:
the second pair of actuator dipole magnets and the second pair of switch dipole magnets each have a magnetic axis;
the pair of second MR sensors each have a magnetic sensitive axis that lies along, or is at least parallel to, the magnetic axes of the second pair of actuator dipole magnets and the second pair of switch dipole magnets; and
the first interposed MR sensor has a magnetic sensitive axis that is perpendicular to the magnetic axes of the second pair of actuator dipole magnets and the second pair of switch dipole magnets.

14. The switch of claim 13, further comprising:
a third pair of actuator dipole magnets coupled to the actuator housing and movable therewith, the third pair of actuator dipole magnets spaced apart from the first and second pairs of actuator dipole magnets;
a third pair of switch dipole magnets coupled to the switch housing and spaced apart from the first and second pairs of switch dipole magnets, the third pair of switch dipole magnets and the third pair of actuator dipole magnets arranged to generate a third quadrupole magnetic field;
a pair of third MR sensors disposed within the switch housing and configured to vary in resistance in response to relative movement of the actuator housing and the switch housing; and
a third interposed MR sensor disposed between the pair of third MR sensors and configured to vary in resistance in response to relative movement of the actuator housing and the switch housing.

15. The switch of claim 14, wherein:
the third pair of actuator dipole magnets and the third pair of switch dipole magnets each have a magnetic axis;
the pair of third MR sensors each have a magnetic sensitive axis that lies along, or is at least parallel to, the magnetic axes of the third pair of actuator dipole magnets and the third pair of switch dipole magnets; and
the third interposed MR sensor has a magnetic sensitive axis that is perpendicular to the magnetic axes of the third pair of actuator dipole magnets and the third pair of switch dipole magnets.

16. The switch of claim 15, wherein each of the first, second, and third MR sensors is a single-axis MR sensor.

17. The switch of claim 15, wherein each of the first, second, and third MR sensors, and each of the first, second, and third interposed MR sensors is a two-axis MR sensor.

18. A magneto-resistance quadrupole magnetic coded switch system, comprising:
a switch housing;
an actuator housing movable relative to the switch housing;
a first pair of actuator dipole magnets coupled to the actuator housing and movable therewith;
a first pair of switch dipole magnets coupled to the switch housing, the first pair of switch dipole magnets and the first pair of actuator dipole magnets arranged to generate a first quadrupole magnetic field;
a pair of first magneto-resistance (MR) sensors, each first MR sensor disposed within the switch housing and configured to vary in resistance in response to relative movement of the actuator housing and the switch housing; and
processing circuitry coupled to the first MR sensors and configured, in response to variations in the resistance of the first MR sensors, to supply one or more switched output signals.

19. The switch system of claim 18, further comprising an electric power source coupled to each of the first MR sensors,
wherein each first MR sensor has a magnetic sensitive axis, and each first MR sensor, when coupled to the electric power source and supplied with current therefrom, supplies a sensor output voltage having a voltage magnitude proportional to magnetic field strength supplied thereto along the magnetic sensitive axis.

20. The switch system of claim 19, wherein the processing circuitry comprises:
signal conditioning circuitry coupled to receive output signals from the first MR sensors and configured, upon receipt thereof, to supply logic-level signals representative of a separation distance of the actuator housing and the switch housing;
logic circuitry coupled to receive the logic-level signals and configured, upon receipt thereof, to supply switch signals; and
solid state switching circuitry coupled to receive the switch signals and configured, upon receipt thereof, to supply the one or more switched output signals.
